(19) United States
(12) Patent Application Publication
(10) Pub. No.: US 2005/0246377 A1
(43) Pub. Date: Nov. 3, 2005

(54) Method and apparatus for a commercial computer network system designed to modify digital music files

(76) Inventor: Paul Leo Faso, Palm Beach Gardens, FL (US)

Correspondence Address: Mitra N. Vahdat, Volunteer Building, Suite 1000, 832 Georgia Avenue, Chattanooga, TN, 37402-2289, US

(21) Appl. No.: 11/155,831

(22) Filed: Jun. 17, 2005

Related U.S. Application Data
(63) Continuation-in-part of application No. 09/439,057, filed on Nov. 12, 1999.

(51) Int. Cl. G04B 13/00; G06F 7/00; G06F 17/00

(52) U.S. Cl. 707/104.1

(57) ABSTRACT

The present invention relates to a novel apparatus and method for effectuating the selection and acquisition or purchase of digital music files. The present invention allows a user to search a digital music collection for a specific base music file. The user then selects a base digital music file and is presented with a plurality of corresponding derivative music files which are pre-created variations of the selected base music file. The user may then select the derivative music file which most precisely fits their unique needs. In an alternate embodiment, the user has the option to select and use one or more modification tools to modify the selected music file to even more precisely fulfill their needs. The user may then purchase the digital music file and, after purchasing, the digital music file may be downloaded or otherwise delivered to the user. Alternatively, the user may load a digital music file provided by the user and select and use one or more modification tools to modify the music file to more precisely meet the user's needs.

This application is a continuation-in-part of pending application Ser. No. 09/439,057, filed Nov. 12, 1999.

### BACKGROUND OF THE INVENTION

1. Field of Invention

The method and apparatus of the present invention relate to the use of electronic computer networks to modify digital music files.

2. Background

Digital music files are widely sold and purchased today online through a wide variety of digital music providers which facilitate the legal exchange of music. These businesses use a method by which a purchaser gains access to their website and searches for or requests a digital music file by title, artist, album, etc. or browses digital music files in various categories such as classical, pop, rock, country, etc. Upon choosing the desired digital music file, the purchaser has the option to play, download or burn the digital music file onto a CD.

Often, individuals seek to make alterations to digital music files in order to precisely meet their particular desires or needs for an intended purpose. For example, after purchasing or creating a digital music file, an individual may wish to cut, copy, paste, delete, insert, silence, autotrim, amplify, normalize, equalize, envelope, reverb, echo, reverse or otherwise modify the music file. The individual may also wish to make more substantial changes to the music file such as removing one or more instruments or vocal tracks, altering the vocals to the voice of a different artist, changing various instruments on the music file from electric to acoustic or vice versa, changing various instruments on the music file from one instrument to another, altering the tempo or pitch, reducing drums or vocals, applying filters to the music to boost or reduce treble or bass, etc.

The method of purchasing digital music files described above, used by businesses today, does not offer purchasers the ability to modify the digital music file to meet the purchasers needs. The purchaser of a digital music file must either accept the digital music file from the database as is, or spend an excessive amount of time and money to purchase software which allows him or her to modify the music file to fit the individual's particular specifications or desires.

In the case of the creator of a digital music file or the owner of a prior purchased digital music file, if the creator or owner wishes to modify the music file to fit the individual's particular specifications, the individual must also spend an excessive amount of time and money to purchase software that allows the individual to modify the music file.

The applicant is unaware of the existence of any commerce system which addresses the above-described shortcomings in the prior art. No web-based programs exist which connect tools that accomplish the various tasks described above into a single matrix. Therefore, it is one object of the present invention to set forth an apparatus and business method that offers the capability for purchasers to create a plurality of variations of a base digital music file, in order to find the variation that most exactly suits the user's needs so that he/she does not have to spend significant additional time, money, or creative effort purchasing software or making modifications.

Accordingly, it is an object of the present invention to provide a method and apparatus for purchasers of digital music files to create a number of variations or presentation forms of the same base digital music file, in order to customize a digital music file that perfectly suits the purchaser's needs so that it does not require further content modification.

More particularly, it is an object of the present invention to provide purchasers of digital music files with pre-modified variations of an original user-chosen base digital music file. Such pre-selected variations may permissibly include, but are not limited to: altering the vocals to the voice of a different artist, changing various instruments on the music file from electric to acoustic or vice versa, altering the tempo or pitch, reducing drums or vocals, applying filters to the music to boost or reduce treble or bass, etc. Of course, each pre-modified version of each digital music file can be further artistically enhanced or modified by the purchaser either at the provider's website using additional tools supplied by the provider, or using the purchaser's own tools. For example, the provider may provide tools which allow the selected digital music file to be further modified by cutting, pasting or deleting certain sections, amplifying, normalizing or equalizing the music file, etc.

Another object of the present invention is to provide a method and apparatus for creators of digital music files or owners of prior purchased music files to gain access to a website which allows the website user to modify or alter music files in order to precisely meet his or her particular desires or needs for an intended purpose.

A first advantage of a presently preferred embodiment is the capability of a purchaser to access pre-modified variations of base digital music files available for purchase in a matter of seconds. The pre-modified variations of the base digital music files do not have to be manipulated or revised, saving the purchaser both time and money.

A second advantage of a presently preferred embodiment is the capability of a user to access a website which allows the user to modify and customize previously purchased or created digital music files.

Another advantage of a presently preferred embodiment is the capability of a purchaser to modify even the pre-modified variation of the base digital music file.

Additional objects and advantages of the invention will be set forth in part in the following description or may be obvious from the description, or may be learned through practice of the invention.

### SUMMARY OF THE INVENTION

The present invention recognizes and addresses the foregoing disadvantages, and others, of prior art apparatus and business methods.

The present invention uses a business method whereby a user or purchaser first accesses a website. Next, they view one or more databases of base digital music files by browsing through them or entering a search query to find a certain file. Each database contains a wide variety of base digital music files ranging from pop music to classical music. Alternatively, users may directly request music files by title or artist, without viewing the entire collection.

After performing a search, users are provided with one or more base digital music files satisfying the search criteria (i.e., containing the requested subject matter). For each base digital music file in each collection there are a plurality of corresponding pre-selected digital music files, referred to as derivative music files, which are variations of the base digital music file which either have been previously created from the base music file and stored for later retrieval or are automatically created upon selection of a base digital music file by the user. Upon selection of the desired digital music file, whether a base or derivative file, the user is then presented with a plurality of options to modify the file. The user can then choose one or more options to customize the music file so that it more precisely satisfies the user's needs. The modified variation is then created and stored by the website proprietor so that it is available to the user within seconds of his selection. The derivative music file choices may range from the basic music file modified to alter the original artist's voice, or modified to alter the tempo or pitch or any other modifications described herein or known and available to those with knowledge of the art.

After selecting the desired digital music file, which may include the original base digital music file or any of its derivative music files, the user indicates to the proprietor that he or she wishes to purchase the selected music file. This transaction is accomplished through an E-commerce transaction of any of the types known in the art. After purchasing one or more digital music files, the digital music can be played, burned or downloaded to the user's computer, disk or CD or any other medium, or ordered for delivery on a disk, CD or any other medium.

Alternatively, the invention uses a business method whereby a user accesses a website containing an online program which allows the user to alter a digital music file provided by the user. First, the user accesses the website. Next, the user selects a music file that the user desires to customize and loads the music file directly on to the website or otherwise gives the website access to the music file. The user can alter the digital music file using a database of pre-selected modification criteria as previously described. The music file can be modified using one or more of the pre-selected modification criteria. The user selects the desired modified music file. Once the user completes the modification and customizes the digital music file, the transaction is accomplished through an E-commerce transaction of any of the types known in the art. The provider can charge users on a per track basis or provide access to the website as a subscription which provides unlimited modifications to digital music files for a period of time. After the purchase has been completed, the digital music file can then be played, burned or downloaded to the user's computer, disk, CD or any other medium, or ordered for delivery on a disk, CD or any other medium.

It is a goal of the present invention to provide a robust system which allows users to search, instantly access, play and purchase base digital music files and/or customized derivatives thereof or alternatively to access an online program that allows users to make modifications to a digital music file provided by the user. Users are able to gain access to a website which allows them to make modifications to digital music files with little time and expense. Users can eliminate the need for their own creative efforts or the expense of hiring an artist to create or alter digital music files. Within a few moments, the present invention enables users to select, modify, purchase and receive a music file which better fits their precise need.

### BRIEF DESCRIPTION OF THE DRAWINGS

FIG. 1 is a block diagram illustrating a preferred embodiment of central controller 20.

FIG. 2 is a block diagram illustrating a preferred embodiment of purchaser interface 50.

FIG. 3 illustrates the process by which a user selects and purchases one or more digital music files.

FIG. 4 illustrates the process by which a user supplies one or more digital musical files.

### DETAILED DESCRIPTION OF THE PREFERRED EMBODIMENTS

Reference will now be made in detail to the presently preferred embodiment of the invention. It will be apparent to those skilled in the art that modifications and variations can be made in the present invention without departing from the scope or spirit thereof. Thus, it is intended that the present invention covers such modifications and variations as come within the scope of the appended claims and their equivalents.

In a preferred embodiment, the present invention includes one or more web-accessible digital music databases that make numerous digital music files available to users. The present invention allows users to access the website and search a digital music database by the title of a particular digital music file, artist or album or by browsing a base digital music collection. Upon selecting a base music file, the user is then presented with a plurality of available pre-selected, pre-modified digital derivative music files based on the selected base music file. In one alternative embodiment, the pre-creation and storage of pre-selected derivative music files allows the user to access a plurality of variations of the original base music file without the additional computer processing time which would otherwise be necessary to create and access the derivatives. In another alternative embodiment, upon selecting a base digital music file, a plurality of pre-selected derivative music files are automatically created.

Upon selecting a base music file, the user is presented with the base music file and a plurality of derivative music files. The user may listen to one or more of the various derivative music files, or may simply select the derivative music file desired. Since the pre-selected derivative music files are modified and produced ahead of time, they can be instantly accessed and listened to.

In one preferred embodiment, the user may be given the option of selecting one or more modification tools through which the user can further modify or edit the selected music file.

Once the user has selected, or selected and further modified, the desired final digital music file, the user is given a number of delivery options such as downloading or copying the digital music file to his computer, a disk, or a CD, or the user may simply order a copy of the digital music file for delivery on disk or CD.

The transaction may be accomplished through an E-Commerce transaction of any of the types known in the art. Alternatively, users can pay a monthly fee for limited or unlimited access to the website.

The present invention allows a user to browse through or search a digital music database 31 comprising one or more collections of base digital music files. The base digital music files may be searched by title, artist, album, music style or, using any other conventional search method. After entering a search criteria, the user is then presented with one or more base digital music files which may be identified by title, artist, album, style or any other identifying characteristics. The user then has the option of listening to each of the base digital music files before selecting a file. After selecting a specific base digital music file, the user is presented with or, alternatively, may request to access a plurality of pre-selected and pre-modified variations of the selected base digital music file, otherwise known as derivative music files. The variations are identified by title and any other identifying characteristics. Alternatively, a plurality of pre-selected derivative music files may be generated upon the user's selection of a base music file and presented to the user.

These derivative music files are generally further manipulations of the base digital music file and include various modifications and special effects to the base digital file. For convenience of accessing the derivative files, the derivative files may be grouped according to alterations to the lyrics, tempo, instruments, etc., with the user being given the option of selectively listening to derivative music files from different groupings.

The derivative music files for each base digital music file of the present invention comprise different versions of the same original base digital music file. These derivative files are music files which might otherwise be created using any of a number of available digital music software applications or tools, and will in fact be created by the website provider through the use of a variety of tools taken from many different software applications. However, the derivative music files of the present invention are pre-created by the website provider or, alternatively, created by the website upon selection of the base music file, so that the results of many different modification techniques from a diverse set of software applications as well as unique artistic modifications by the website provider are available for the user upon selection of a single base music file. Thus, users avoid having to take the base music file, purchase each of the different software applications and use the tools available thereon in order to explore the possibilities resulting from a base music file. In the present invention, this work is already done and the user can simply avail himself of the fruits of that labor, thereby saving considerable time and expense.

After listening to and selecting one or more base or derivative music files, the user may be given the option to select from one or more tools or special effects to further modify or edit the selected digital music file. Thus, a user is able to find and purchase a music file that completely accommodates the desired objective of the user with relative ease.

Alternatively, the user can access these techniques from a diverse set of software applications as well as unique artistic modifications provided by the website provider in order to modify a digital music file provided by the user. The user simply loads the music file from its computer, CD or any other medium directly on to the website. This may be accomplished by the website having any one of a number of widely available programs which allow users to load music directly on to the website or grant the website access to the user's music files. For example, this can be accomplished using a CD ripper which extracts audio tracks from music CDs to computer files. The user is then given the option to select from one or more tools or special effects to manipulate and customize the digital music file.

System Architecture

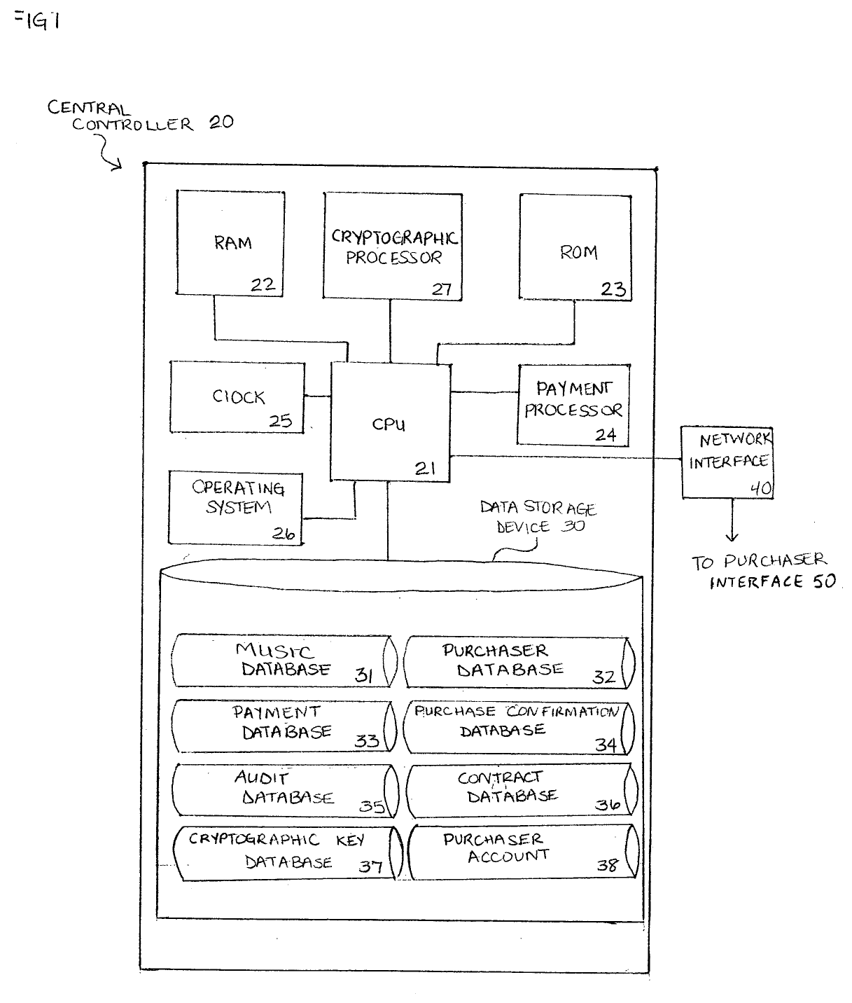

The system architecture of a first embodiment of the apparatus and method of the present invention is illustrated in FIGS. 1 through 3.

As shown in FIGS. 1 & 2 the apparatus of the present invention comprises a central controller 20 and a purchaser interface 50 (collectively the “nodes”). Each node 20, 50 is connected via an Internet connection. Connection may be provided by any common computer network connection means such as broadband, DSL, dedicated data lines, cellular, Personal Communication Systems (“PCS”), microwave, or satellite networks. Purchaser interface 50 is the input gateway for communications with central controller 20.

As shown in FIG. 1, the central controller 20 includes central processor (CPU) 21, cryptographic processor 27, RAM 22, ROM 23, payment processor 24, clock 25, operating system 26, network interface 40, and data storage device 30.

Central controller 20 acts as a web server receiving instructions and orders from users. A conventional personal computer or computer workstation with sufficient memory and processing capability may be used as central controller 20. Central controller 20 must be capable of high volume transaction processing and performing a significant number of database searches. Any commercially available CPU which is able to process and perform the tasks described may be used for Central Processor (CPU) 21.

A MC68HC16 micro-controller, commonly manufactured by Motorola Inc., may be used for cryptographic processor 27. Equivalent cryptographic processors may also be used. This micro-controller utilizes a 16-bit multiply-and-accumulate instruction in the 16 MHz configuration and requires less than one second to perform a 512-bit RSA private key operation. Cryptographic processor 27 allows for secure transactions. Cryptographic processor 27 may also be configured as part of CPU 21. Adequate RAM 22 and ROM 23 are provided to assist in the processing of data.

Payment processor 24 comprises one or more conventional microprocessors, supporting the transfer of payments, charges, or debits, attendant to the method of the apparatus. Payment processor 24 may also be configured as part of CPU 21. Processing of credit card transactions by payment processor 24 may be supported with commercially available software, such as, for example, the Secure Webserver manufactured by Open Market, Inc. This server software transmits credit card numbers electronically over the Internet to servers located at the Open Market headquarters where card verification and processing is handled. Their Integrated Commerce Service provides back-office services necessary to run Web-based businesses. Services include on-line account statements, order-taking and credit card payment authorization, credit card settlement, automated sales tax calculations, digital receipt generation, account-based purchase tracking, and payment aggregation for low priced services. Clock 25 is a standard chip-based clock which serves to time stamp the transaction.

Data storage device 30 may include hard disk magnetic or optical storage units, as well as CD-ROM drives or flash memory. Data storage device 30 contains digital music database 31, a database of base digital music files and a plurality of corresponding derivative music files which have been pre-created from each base digital music file. Of course music database 31 may be organized as one or more music collections or in any convenient way conducive to aiding the user in searching, locating and listening to the base digital music files and derivative music files. Alternately, music database 31 may contain only the collection of base digital music files with the pre-modified versions of each base digital music file stored in one or more separate databases (not shown).

Additionally, data storage device 30 comprises other databases used in the processing of transactions of the present invention, including purchaser database 32, payment database 33, purchase confirmation database 34, audit database 35, contract database 36, and cryptographic key database 37. These databases can be created and managed by various software applications, such as Oracle7, manufactured by Oracle Corporation. Data storage device 30 also stores information pertaining to purchaser accounts in purchaser account database 38.

Purchaser database 32 maintains data on users with fields such as name, address, credit card number, phone number, social security number, electronic mail address, credit history, digital music files sold, past system usage, and private information, etc. This information is obtained when the user first purchases digital music files, or may be obtained prior to listening to digital music files.

Payment database 33 tracks all payments made by the users with fields such as user name, ID number, amount of payment, and digital music file purchased. This database may also store credit card numbers of users.

Purchase confirmation database 34 stores and tracks the digital music files to be sent to the user and confirms completed transactions. Fields include user name, elected digital music files and purchased digital music file(s).

Audit database 35 stores transactional information relating to the purchasing of digital music files, allowing them to be retrieved for later analysis.

Contract database 36 keeps track of all sales of digital music files, including user's name, method of payment, date, time, and method of receiving digital music files. This information is then retrieved in order to satisfy orders by mail.

Cryptographic key database 37 facilitates cryptographic functions, storing both symmetric and asymmetric keys. These keys are used by cryptographic processor 27 for encrypting and decrypting user responses and user payment information.

Purchaser account 38 tracks all information pertaining to the user's account with fields such as user's name, bank and credit account numbers, and debit or credit transactions.

Network interface 40 is the gateway to communicate with user through purchaser interface 50. Network interface 40 is configured as a website. Conventional internal or external modems may serve as network interface 40.

While the above embodiment describes a single computer acting as central controller 20, those skilled in the art will realize that the functionality can be distributed over a plurality of computers. In one embodiment, central controller 20 is configured in a distributed architecture, wherein the databases and processors are housed in separate units or locations. Some controllers perform the primary processing functions and contain at a minimum RAM, ROM, and a general processor. Each of these controllers is attached to a WAN hub (not shown) which serves as the primary communication link with the other controllers and purchaser interface 50. The WAN hub (not shown) may have minimal processing capability itself, serving primarily as a communications router. Those skilled in the art will appreciate that an almost unlimited number of controllers may be supported. This arrangement yields a more dynamic and flexible system, less prone to catastrophic hardware failures affecting the entire system.

In an exemplary embodiment, purchaser interface 50 is a conventional personal computer having an input device 59, such as a keyboard, mouse, or conventional voice recognition software package; a display device, such as a video monitor 60; a processing device such as a CPU 55; and a network interface such as a modem 58, and speakers 62 to allow the user to listen to the digital music files. These devices interface with central controller 20.

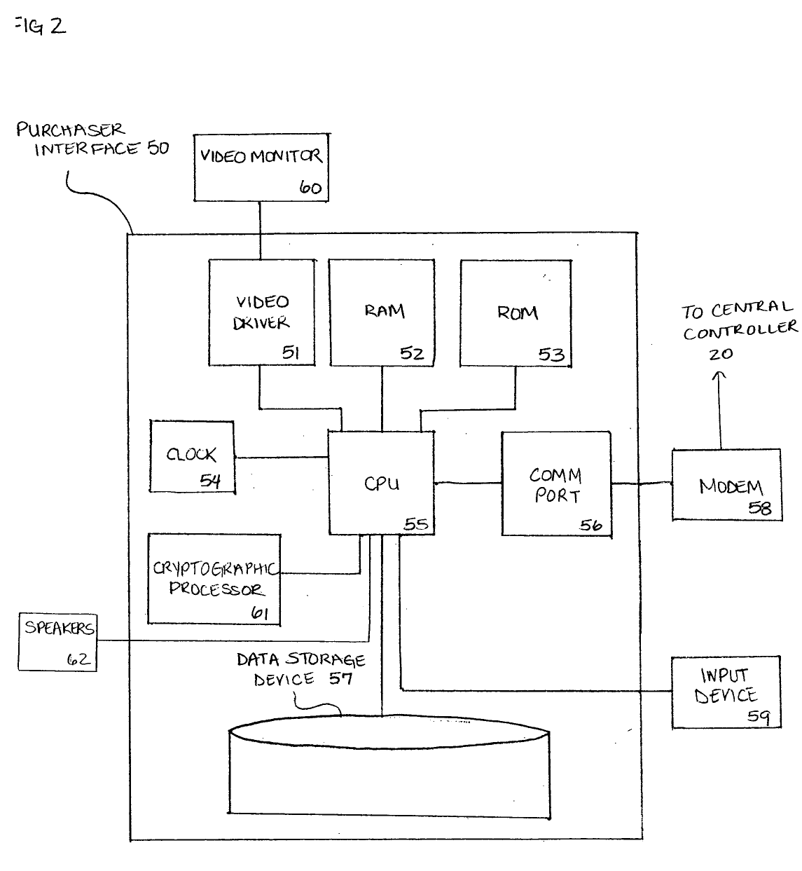

Referring now to FIG. 2, there is described purchaser interface 50 which includes central processor (CPU) 55, RAM 52, ROM 53, clock 54, video driver 51, video monitor 60, speakers 62, communication port 56, input device 59, modem 58, data storage device 57, and cryptographic processor 61. Any commercially available CPU which is able to process and perform the tasks described may be used for Purchaser Central Processor (CPU) 55. Clock 54 is a standard chip-based clock which can serve to time stamp the sale. Modem 58 is preferably high-speed data transfer since most provider responses are not primarily text-based and contain large audio files. Data storage device 57 is a conventional magnetic-based hard disk storage unit.

Cryptographic processor 61 may be added for stronger security, particularly for protecting user information such as credit card numbers. If a cryptographic processor is required, the MC68HC16 micro-controller described may be used. The practice of using cryptographic protocols to ensure the integrity of messages is well known in the art and need not be described here in detail.

There are many commercial software applications that can enable the communications required by purchaser interface 50, the primary functionality being message creation and transmission. Eudora Pro manufactured by Qualcomm Incorporated, for example, provides editing tools for the creation of messages as will as the communications tools to route the message to the provider. Since central controller 20 is configured as a web server, conventional communications software such as the Netscape navigator web browser from Netscape Corporation may also be used. The user may use the Netscape Navigator browser to transmit messages to the provider. No proprietary software is required as the typical purchaser interface 50 is packaged with the necessary audio and video software.

Preferred Embodiment

Communications with the user take place via electronic networks, with central controller 20 acting as a web server. The user logs on to central controller 20, browses or searches a collection of base digital music files or specifically requests a base digital music file by title, and selects base digital music file and then selects the desired derivative music file of the selected base music file. At all times the user has the ability to listen to the music file being manipulated. As described above, the user may then modify the selected digital music file, purchase the music file, perform additional searches for other music files or simply disconnect from the website. This service is made available to users by posting it on the web page of central controller 20.

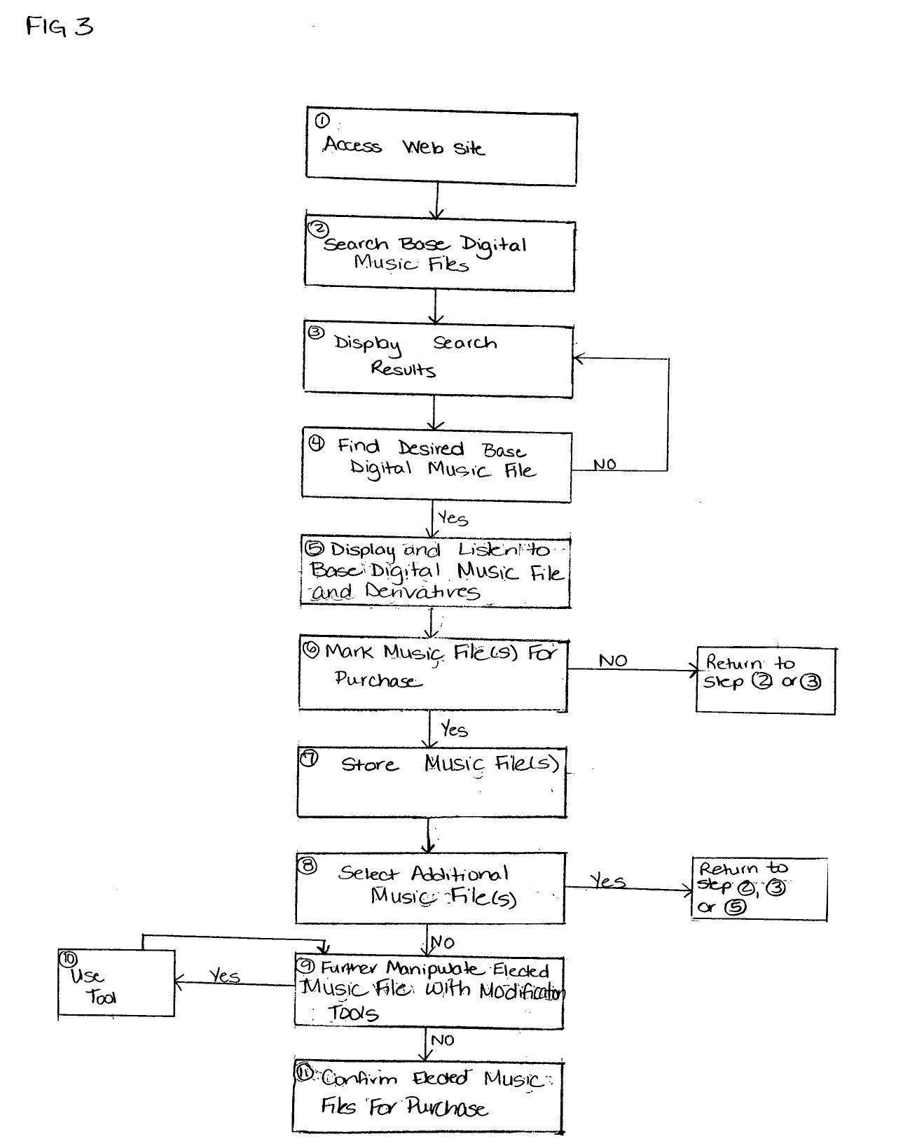

FIG. 3 illustrates the process by which the user selects and purchases one or more desired digital music file(s). At step 1, user logs on to central controller 20 using purchaser modem 58 of purchaser interface 50, establishing a communications link and accessing the site. It should be noted that the user may be an individual, a corporation, a partnership, a government, or any other entity. Central controller 20 has a page on the world wide web, allowing the user to provide information through the interface of conventional web browser software such as Internet Explorer, manufactured by Microsoft Corporation or Netscape Navigator, manufactured by Netscape, Inc.

At step 2, the user is prompted to search or browse a database of base digital music files. Alternately, the user may be provided with the option of specifically requesting a known base digital music file by title or a derivative music file according to a music classification system (not shown in FIG. 3). The music database 31 (shown in FIG. 1) is organized to facilitate the search and retrieval of base digital music files. Any common method of searching and retrieving information and files from a database is suitable to the present invention, such as the preferred searching by title or artist of the music file. Detailed referencing of the base music files in the database enhances searchability. Suitable search subjects may include, but are not limited to, title, artist, album, movie, music category such as classical, pop, rock, country, etc. . . . Base music files falling within each of those classes may be further subclassified within the database to promote accessibility, for example, the pop class may be further sub-classified into '80s or 90's music. A user may also be able to locate a music file by entering lyrics contained in the music file.

Upon entering a search request, as shown in FIG. 3, the user is provided at step 3 with a display of the search results, a collection of base digital music files gleaned from the music database 31 which satisfy the search criteria input by the user. The resulting base digital music files titles along with other identifying characteristics of the music file such as artist and album are displayed on the video monitor 60 of purchaser interface 50 (shown in FIG. 2). Lyrics of each digital music file may also be displayed on the video monitor 60 of purchaser interface 50. The user has the option of listening to each digital music file satisfying the search criteria. If no digital music files satisfy the search criteria, the user is prompted to enter a different search.

At step 4, user either selects one of the displayed base digital music files or, if no desirable music file is found, may return to step 2 and conduct a new search. Upon selection of a base digital music file, in step 5 the selected base music file and a plurality of pre-created derivative music files stored in the database corresponding to the selected base digital music file are displayed by title along with other identifying characteristics of the music file such as artist, album and the character of the derivative on the video monitor 60 of purchaser interface 50. If desired, the user can select one or more of the music files to listen to.

As previously described, the derivative music files are a plurality of music files based upon the original base digital music file. The derivative music files are created prior to the user's selection of the base digital music and are an existing part of the present invention stored in the music database 31. Because all of the derivative music files are pre-created and stored in the music database 31, no additional processing time or manipulation of the base music file is required to create the various derivative music files when the base music file is selected by the user. The wide variety of derivative music files provided saves the user significant time in having to perform modifications upon the base digital music file at his own expense. Instead, upon the selection of a base music file, the user is presented with a plurality of derivative music files, one of which may be better suited to the user's intended end-use than the original base digital music file itself.

Alternatively, upon the user's selection of a base music file in step 4, the central controller 20 may be programmed to generate a pre-defined or a user defined set of derivative music files for presentation to the user in step 5.

At step 6, user may select or mark either the base music file or a derivative music file as an elected music file which the user desires to purchase. If the user does not find a suitable music file, the user may choose to return to either step 3 to review the search results or step 2 to begin a new search. When the user elects to purchase a music file, the elected music file is stored or tagged for reference as an elected music file in step 7. After storing an elected music file, in step 8, the user is prompted to either continue or select additional music files by repeating one or more of the foregoing steps of the process.

In one alternative embodiment, after one or more music files are stored by the user as elected music files, in step 9 the user may be given the option of further manipulating an elected music file using one or more tools or special effects which may be provided through the website. Such tools may be any of the myriad existing software applications which may be added on to the website to allow the user to further modify the elected music file to better suit the user's needs, such as by further modification and editing of the music file as previously described. Alternately, the availability of modification tools may be limited until after the user has actually completed the E-commerce transaction of step 11 wherein the elected music files are actually purchased. If desired, modification tools are employed by the user in step 10 and the process of steps 9 and 10 repeated until the user has modified each of the elected music files utilizing all of the available modification tools to create the desired music file. If desired, a user friendly music browser with simple modification buttons may be created to simplify the modification process.

Once user has achieved the desired elected music file(s), at step 11 user may continue to complete the purchase of the music file(s). The purchasing step 11 is a typical E-commerce transaction which may take many different embodiments, the specifics of which are largely irrelevant to the present invention. In one embodiment, the user clicks on a purchase button at which time a form is displayed on the video monitor 60 of purchaser interface 50. This form is an electronic contract which includes a list of the elected music file(s), pricing information for the elected music file(s) as well as a number of blanks to be filled out by the user, including: name, address, phone number and billing information such as preferred method of payment or credit card number. After filling out the information, user sends this information back to the central controller 20 by clicking on a “send” button located on the screen in which he entered the above information. Once the payment information has been processed, the user is given complete access to the data of the computer file(s) which comprises the elected music file(s) and may play, download to a computer, disk or CD, or have the elected music file(s) mailed or otherwise delivered to him/her on disk or CD.

Referring back to the processing of the payment information, if the payment method is by credit card, the contract is received by the central controller 20 and checked to see that sufficient credit is available to cover the stated price of the music file, before the music file is made available to the user. The central controller 20 extracts price, credit card number and expiration date information from the electronic contract. The payment processor 24 uses E-commerce mechanisms known in the art to communicate with the credit card clearing house and finalize the credit card purchase.

There are of course many other methods under which payment may be transferred. Purchaser can select his preferred method of payment which may include credit card, personal checks, electronic funds transfer, digital money, etc. Credit card transactions are handled through E-commerce payment mechanisms known in the art. These payment methods are meant to be merely illustrative, however, as there are many equivalent payment methods commonly known in the art which may also be used. If the buyer wants to pay by credit card, for example, payment data would include his credit card account number, expiration date, name of issuing institution, and credit limit. For electronic funds transfer, payment data includes the name of the buyer's bank and his account number. Although the preferred embodiment describes a protocol in which users pay prior to receiving the digital music file, other embodiments may be implemented in which payment is delayed until the goods have been received by the user, or delayed until some predetermined date. Partial payments and installment payments are also supported by the system. In another embodiment, the user may make a partial payment upon purchase, and then complete payment when the digital music file(s) are received. The method and apparatus of the present invention may also be employed by providing users the right to access the website as a subscription which provides unlimited digital music files and modifications for a period of time. Alternatively, the method and apparatus of the present invention may be employed without a payment feature.

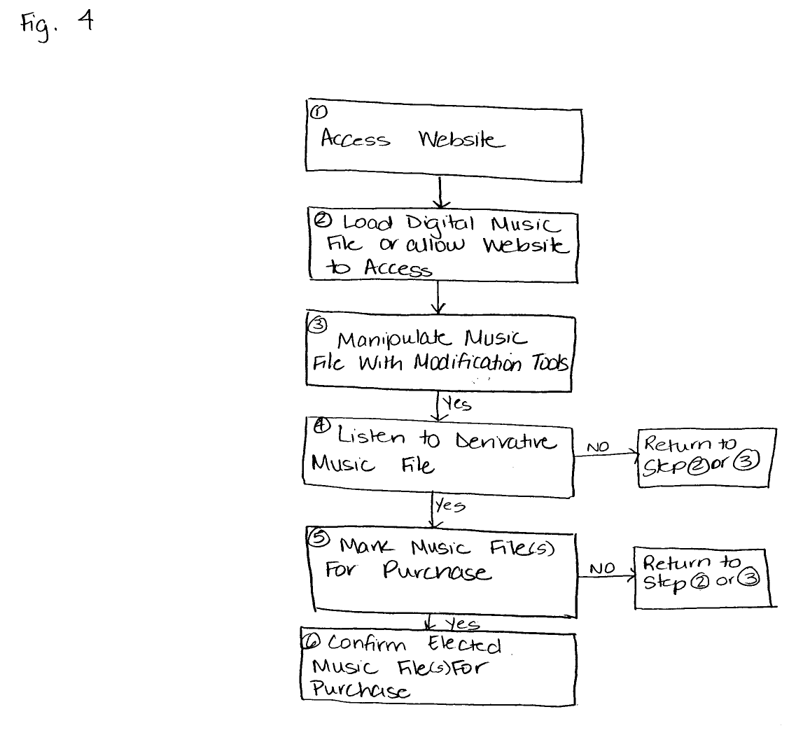

Referring now to FIG. 4, in the case of when a user desires to alter or modify music files created by the user or previously purchased, at step 1, user logs on to central controller 20 using purchaser modem 58 of purchaser interface 50, establishing a communications link and accessing the site.

At step 2, the user is prompted to load one or more selected music files which the user desires to modify on to the website. Alternatively, the user can grant the website access to the user's music files. Once this has been completed, at step 3 the user is given the option of manipulating the selected music files using one or more modification tools which may be provided through the website, as previously described. Alternately, the availability of modification tools may be limited until after the user has actually completed the E-commerce transaction (as previously described) wherein the user purchases access to the website. Modification tools are employed by the user in step 3 and the process of step 3 may be repeated until the user has modified the music utilizing all of the available modification tools to create the desired music file.

Once user has achieved the desired elected music file(s), at step 4 the user has the option to listen to one or more derivative music files. At step 5 the user may mark one or more selected music file(s) for purchase. Next, the user may continue to complete the purchase of the music file(s), as previously described or return to any one of steps 2 or 3 to load additional digital music files or further manipulate the music file. The purchasing step may be completed by any of the E-Commerce transaction types known in the art and previously described. Alternatively, users can pay a monthly fee for limited or unlimited access to the website.

While several embodiments of the present invention have been disclosed, it is to be understood by those skilled in the art that other forms can be adopted, all coming within the spirit of the invention and scope of the appended claims:

1. An apparatus for facilitating the selection and acquisition of digital music files, comprising:
a storage device; and
a processor connected to the storage device, the storage device storing a program for controlling the processor; and
the processor operative with the program to:
receive search criteria regarding digital music files from a user;
make one or more base digital music files satisfying the search criteria available for the user to listen to;
receive input from the user to select a base digital music file;
display a plurality of derivative digital music files corresponding to the base digital music file selected by the user;
play a plurality of derivative digital music files corresponding to the base digital music file selected by the user; and
receive input from the user to elect one or more derivative digital music files for acquisition by the user.

2. The apparatus of claim 1 wherein the derivative music files further comprise a plurality of pre-modified variations of the selected base digital music file.

3. The apparatus of claim 1 wherein the derivative digital music files have been created prior to the user's selection of the base digital music file and are stored in the storage device.

4. The apparatus of claim 3 wherein the derivative digital music files further comprise the selected base digital music file.

5. The apparatus of claim 1, further comprising the processor operative with the program to make the selected derivative digital music file available to the user to download.

6. The apparatus of claim 1, further comprising the processor operative with the program to:
receive payment information from the user; and
process the payment information to finalize the acquisition of the elected derivative music file.

7. The apparatus of claim 1, further comprising the processor operative with the program to:
receive tool input from the user to select a modification tool; and
allow the user to modify the elected derivative music file using the selected modification tool.

8. A method for using a computer to facilitate the selection and acquisition of digital music files, comprising:
inputting into the computer search criteria regarding digital music files;
outputting one or more base digital music files which satisfy the search criteria;
inputting into the computer a selection of one or more of the base digital music files;
outputting a plurality of derivative music files corresponding to the selected base digital music file;
inputting into the computer an election of one or more derivative music files for acquisition by a user; and
outputting one or more selected derivative music files for acquisition by the user.

9. The method of claim 8 wherein the derivative music files have been created prior to the selection of the base digital music file and are stored in a storage device of the computer.

10. The method of claim 9 wherein the derivative music files further comprise the selected base digital music file.

11. The method of claim 8, further comprising the steps of:
inputting into the computer a selection of a modification tool; and
utilizing the modification tool to modify the selected derivative music file.

12. The method of claim 8 wherein the step of outputting one or more elected derivative music files for acquisition by the user further comprises the steps of:
inputting into the computer payment information;
outputting payment authorization for the elected derivative music file; and
outputting the elected derivative music files to the user.

13. The method of claim 8 wherein the step of outputting a plurality of derivative music files corresponding to the selected base digital music file further comprises the steps of:
retrieving the derivative music files corresponding the selected base digital music file from a storage device of the computer; and
displaying and playing the derivative music files from the speakers of the computer.

14. The method of claim 8 wherein the step of outputting one or more base digital music files which satisfy the search criteria further comprises the steps of:
searching a database of base digital music files in the computer based on the search criteria;
displaying and playing the base digital music files which satisfy the search criteria on the speakers of the computer.

15. An apparatus for facilitating the modification of digital music files, comprising:
a storage device; and
a processor connected to the storage device, the storage device storing a program for controlling the processor; and
the processor operative with the program to:
receive a digital music file from the user;
receive tool input from the user to select a modification tool; and
allow the user to modify the digital music file provided by the user using the selected modification tool; and
display one or more derivative digital music files corresponding to the digital music file provided by the user;
play one or more derivative digital music files corresponding to the digital music file provided by the user; and
receive input from the user to elect one or more derivative digital music files for acquisition by the user.

16. The apparatus of claim 15, further comprising the processor operative with the program to: receive payment information from the user; and
process the payment information to finalize the acquisition of the selected derivative music file.
